(19) United States
(12) Patent Application Publication
(10) Pub. No.: US 2008/0174862 A1
(43) Pub. Date: Jul. 24, 2008

(54) Specimen Holder For Microscopy

(76) Inventor: Daniel C. Focht, Fenelton, PA (US)

Correspondence Address: Beck & Thomas, P.C.;SUITE 100, 1575 McFARLAND ROAD, PITTSBURGH, PA, 15216-1808, US

(21) Appl. No.: 12/015,618

(22) Filed: Jan. 17, 2008

Related U.S. Application Data
(60) Provisional application No. 60/886,016, filed on Jan. 22, 2007.

(51) Int. Cl. G02B 21/26

(52) U.S. Cl. 359/391

(57) ABSTRACT

The present invention relates generally to microscopy and, more particularly, to a novel specimen heating and retaining assembly designed to eliminate or reduce z-axis drift during microscopic examination of heated specimens. Attributes of the novel system of the present invention include that it has a minimal thermal mass allowing temperature to be changed/controlled more rapidly. Additionally the heat dissipated by this minimal thermal mass is insulated from the stage of the microscope which greatly reduces the thermal expansion of the scope stage and scope body. The support surface of the heated plate is coplanar with the specimen plane so that the dimensional changes that occur due to changes in heat do not affect the Z axis position of the specimen. The novel system of the present invention is also adjustable so that the end user can compensate for variations in the thicknesses of a variety of commercially available plastic ware and glass slides.

### CROSS-REFERENCE TO RELATED APPLICATIONS

This application claims the benefit of U.S. Provisional Application No. 60/886,016 filed Jan. 22, 2007.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### BACKGROUND OF THE INVENTION

1. Field of the Invention

The present invention relates generally to microscopy and, more particularly, to a specimen holder designed to eliminate or reduce Z-axis drift during microscopic examination of heated specimens so that the specimen can remain in focus.

2. Description of the Prior Art

The examination and observation of microscopic specimens is of great interest to scientists and engineers doing research in the physical and biological sciences. Specimen size can range from tens of microns to sub-micron. It is also of great scientific value to study the effects of experimental treatments on such specimens and to examine any changes, modifications, transformations, and other effects that result from experimental treatments of these specimens. As the specimens or portions of specimens being analyzed are of extremely small dimensions and they are observed in very advanced microscopes such as: atomic force microscopes (AFM), and optical microscopes using techniques such as serial plane deconvolution, confocal imaging, multi-photon imaging, total internal reflection fluorescence (TIRF) and other electronic or optical, including but not limited to reflected light or transmitted light microscopes.

Often, it is desirable to control the temperature of a specimen undergoing microscopic examination. The goal may be to raise the temperature or to lower it. See for example U.S. Pat. No. 5,598,888 where cryogenics is employed to cool the specimen. Where heat is employed, such heat may be used to impart heat energy to the specimen being examined to maintain its physiological conditions or induce changes or effects in the specimen. In the case of mammalian specimens biologists often need to warm a specimen, cells or tissue to physiological temperatures on a microscope to study them.

Historically biologists needing to warm a specimen, cells or tissue to physiological or other temperatures on a microscope have simply placed the specimen in either a glass or plastic vessel (culture dish or glass slide) onto a metal carrier plate that is peripherally heated. The source of the heat is usually electro-resistive, Peltier or circulation of a pre-warmed fluid. The previously used method has been to heat the entire plate so that a specimen placed on the plate will absorb the heat. This does warm the specimen to some extent, but this technique induces problems that can interfere with high resolution microscopy.

These problems include: 1) that peripheral heat transfer is inefficient; 2) that an overly large surface of metal is heated; 3) that more heat is transferred to the stage of the microscope by conductive means than reaches the specimen by radiative means because there is more of the heated plate in direct physical contact with the stage than is in contact with the specimen; 4) that the heat transferred to the stage undesirably warms the scope; and 5) that the heat causes thermal expansion of the heating plate. These latter two are important contributors to a phenomenon known as Z-axis shift or Z-axis drift.

In the traditional configuration, the specimen, heating plate and stage are stacked. When a specimen is placed on the plate and the plate is heated, the plate, being made of metal, will expand relative to its support surface, the microscope stage, as heat is applied, causing the specimen to move as the plate expands. The specimen moves with the plate, as the metal plate expands in a perpendicular or Z-axis direction. Therefore, the specimen is moved out of focus.

If the plate were simply heated and expanded but could be held at that temperature this might help reduce or eliminate Z-axis shift in that the specimen might move in the Z-axis upon heating to a position and stay there if the heat was constant. However, the large thermal mass of the plate inhibits the ability to maintain consistency of temperature control. Thermal inertia makes accurate thermal regulation difficult. Therefore, as the plate cools and retracts during the cycles of the heating and cooling process, the specimen again moves with the contractions and expansions of the plate along a Z-axis, again moving the specimen in and out of focus. This is a common complaint of many in the microscopy community and numerous references can be found on the Microscopy Society of America MSA microscopy list server http://www.microscopy.org.

In addition to the sensitivities of many modes of microscopy themselves to Z-axis shift, there is yet another important problem associated with Z-axis drift that affects nearly all modes of microscopy and that is the problem of Z-axis drift when coupled with time lapse examination of a specimen.

In circumstances where it is desired to examine the specimen over a long period of time, for example, it is often the case that a photographic or digital camera may be associated with the microscope to capture time-lapsed images of the specimen being examined, and it is not uncommon for such analysis to span over hours or even days. Time lapse images are for example, commonly used with techniques such as serial plane deconvolution microscopy, confocal microscopy, multi-photon microscopy and TIRF microscopy. Z-axis drift can ruin or make useless data collected from time lapse analysis with such microscopic techniques.

And, as may be appreciated, the longer the time lapse, the worse the problem. Several factors contribute to the problem including but not limited to: 1) the observation of cells requires high magnification objectives; 2) high magnification objectives typically have a narrow, sub-micron depth of focus. Therefore, very slight Z-axis movement takes the image out of focus; 3) new even more sensitive modes of microscopy such as confocal, multi-photon, TIRF and serial plane deconvolution place tighter demands on the need to maintain the Z-axis position of a specimen because they are particularly sensitive to Z-axis drift; and 4) the thermal expansion of the mechanically supportive components of the microscope, especially the warming system can be a major contributor to Z-axis drift.

One approach to combat Z-axis drift has been to try to avoid fluctuations in the temperature by bringing the specimen to a constant temperature and holding it there. See for example my prior U.S. Pat. No. 5,552,321 directed to a temperature controlled culture dish apparatus which is ideally suited for holding biological specimens at constant temperature.

See also my prior U.S. Pat. No. 5,410,429 directed to a heater assembly for microscope objectives. In that patent I explained that when using light microscopes with immersion objectives for observing and studying different samples or specimens it is often necessary that temperature control of the samples be accurately maintained. This need for temperature control is especially required in live cell chamber microscopy to accommodate the characteristics of different samples. Temperatures must be maintained or controlled in the media flow region, and once the required temperature has been obtained it must be stabilized. As explained further, my U.S. Pat. No. 4,974,952 issued on Dec. 4, 1990, describes even more fully the need for stabilized and accurate chamber temperature in live cell chambers. It has been found that the temperatures of microscope objectives has an effect on the temperature of live cells in chambers. It is, therefore, necessary to maintain a desired temperature of the microscope objectives so that the live cell chamber temperatures are properly maintained to thereby insure the proper characteristics of the samples being studied.

Other attempts to overcome Z-axis drift have been to accept the fact that the specimen will undergo Z-axis drift, but to attempt to overcome that drift with complicated and/or expensive opto-mechanical devices which attempt to compensate for Z-axis drift with a focus feedback system.

Currently about six popular companies produce heating plates for microscopes, and they all have similar characteristics. These include: 1) that they heat a comparatively large plate with respect to specimen size; 2) that the specimen rests on a heated metal plate that is in direct contact with the surface of the stage; 3) that the Z-plane position of the specimen is additive due to thermal expansion with reference to the stage surface; 4) that they use an excessive amount of energy to warm a small specimen; and 5) that excessive heat is transferred to the stage of the microscope thus increasing Z-axis drift.

While my aforementioned U.S. patents each accomplished the objectives set forth therein respectively, and while there are some expensive complicated systems that attempt to compensate for Z-axis drift, there remains a need in the art for relatively simple and inexpensive mechanism for the control or elimination of Z-axis drift of a specimen undergoing thermal regulation for microscopic examination.

### BRIEF SUMMARY OF THE INVENTION

One object of the present invention is to provide a novel microscope plate for heating a specimen while on a microscope which is relatively inexpensive to produce yet reduces or eliminates Z-axis drift as the specimen is heated and/or cooled during microscopic examination of the specimen.

Another object of the present invention is to provide an improved methodology of warming specimens and of conducting microscopic examinations of specimens while reducing or eliminating Z-axis drift.

The novel microscope plate of the present invention for heating a specimen while on a microscope includes:
a. a plate structure having minimal thermal conductivity and a minimal expansion coefficient;
b. a support surface on the plate structure; and
c. a specimen holder that is located on or within the support surface of the plate structure that is supported by the microscope such that the specimen support surface of the plate structure is at or near the same horizontal plane as a specimen within the specimen holder so that there is minimal Z-axis shift of the specimen when the specimen holder is heated.

Attributes of the novel system of the present invention include that it has a minimal thermal mass allowing temperature to be changed/controlled more rapidly. Additionally the heat dissipated by this minimal thermal mass is insulated from the stage of the microscope which greatly reduces the thermal expansion of the scope stage and scope body. The support surface of the heated plate is coplanar with the specimen plane so that the dimensional changes that occur due to changes in heat do not affect the Z-axis position of the specimen. The novel system of the present invention is also adjustable so that the end user can compensate for variations in the thicknesses of a variety of commercially available plastic ware and glass slides.

### BRIEF DESCRIPTION OF THE DRAWINGS

FIG. 1 is a perspective view of the novel specimen heating and retaining assembly of the present invention shown in use on the stage of a standard inverted microscope. A specimen dish and a heating element that does not form a part of the present invention are illustrated in phantom.

FIG. 2 is a perspective cross-sectional view of the novel specimen heating and retaining assembly of the present invention along the line II-II of FIG. 1.

FIG. 3 is a cross-sectional schematic elevational exploded view, also along the line II-II of FIG. 1

### DESCRIPTION OF THE PREFERRED EMBODIMENTS OF THE INVENTION

As may be appreciated by those skilled in the art, specimens may be examined in different spatial arrangements, and the terms top, bottom, left, right, may be subject to change depending upon the orientation of the specimen. However for purposes of the following discussion, it shall be understood that the stage of a microscope forms a horizontal supporting surface for a specimen being examined, with both the specimen and the stage having a flat X-axis and a Y-axis, and that “vertical” shall refer to the Z-axis perpendicular to the X,Y plane.

For reference purposes the following Thermal Expansion coefficient of materials is noted Aluminum 12.3×10̂−6 in/in/° F., Derlin 4.5 Ê−5 in/in/° F., glass (ordinary), 5×10̂−6 in/in/° F., Glass (pyrex), 2.2×10̂−6 in/in/° F., Quartz, 0.33×10̂−6 in/in/° F. For reference purposes the following thermal conductivity is noted—k−(W/m K) Aluminum 250, Brass 109, Copper 401, and Glass 1.05. For purposes of the claims minimal expansion coefficient means less than 10×10̂−6 in/in/° F. or low enough so that there is no visible change in viewing the specimen. For purposes of the claims minimal thermal conductivity means less than 200 or low enough so that there is no visible change in viewing the specimen.

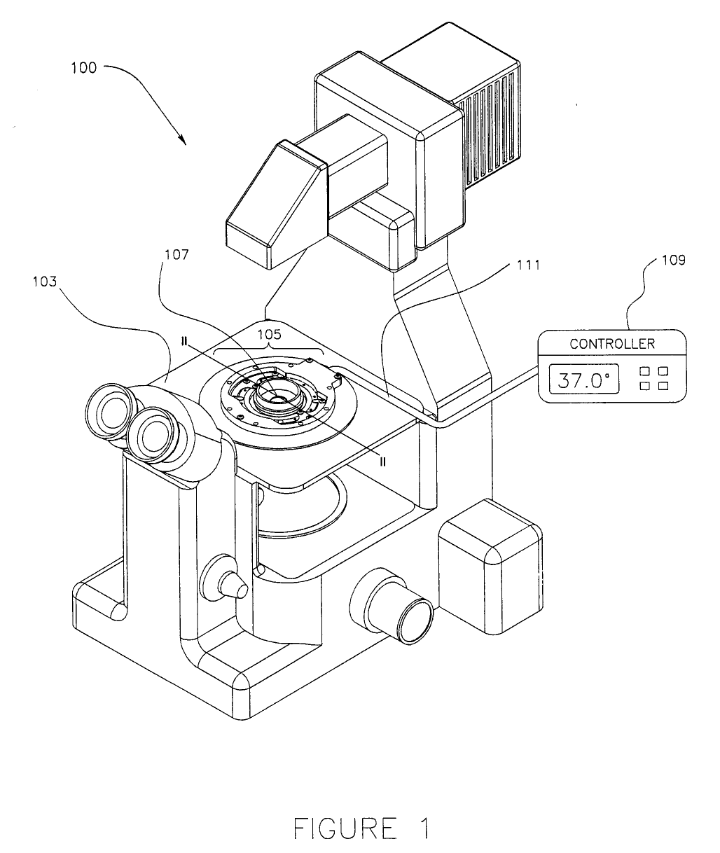

Illustrated in FIG. 1 in phantom is a microscope 100 having a stage 103. On stage 103 is shown one embodiment of the novel specimen heating and retaining assembly 105 of the present invention discussed in more detail below. Located above the assembly 105 but not forming a part of the present invention, there is illustrated for informational purposes a specimen dish 107 in which a specimen of interest for microscopic examination would be present. Also illustrated in FIG. 1 is a heating controller 109 which also does not form part of the present invention. While heating elements can vary widely and are not limiting to the present invention, for purposes of this discussion heating controller 109 is connected via electrically conductive wires 111 to a heating electroresistive heater to heat the specimen as discussed in more detail below.

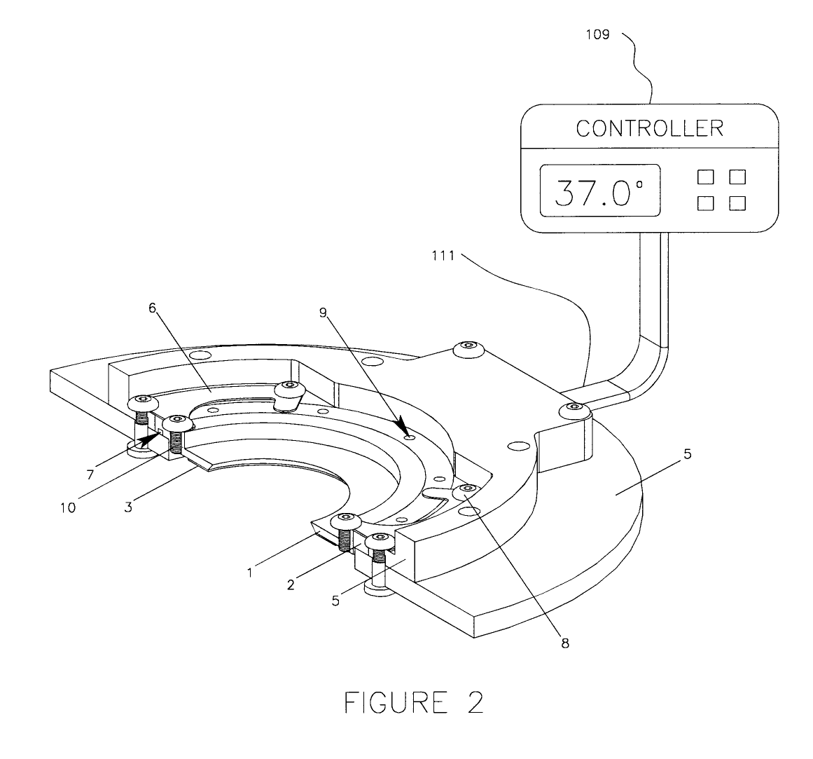

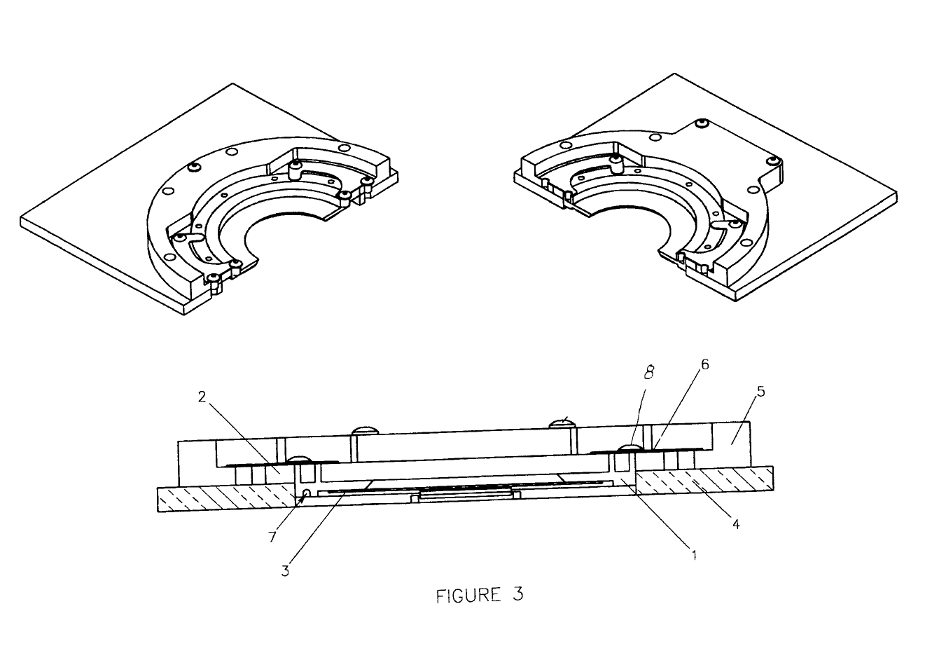

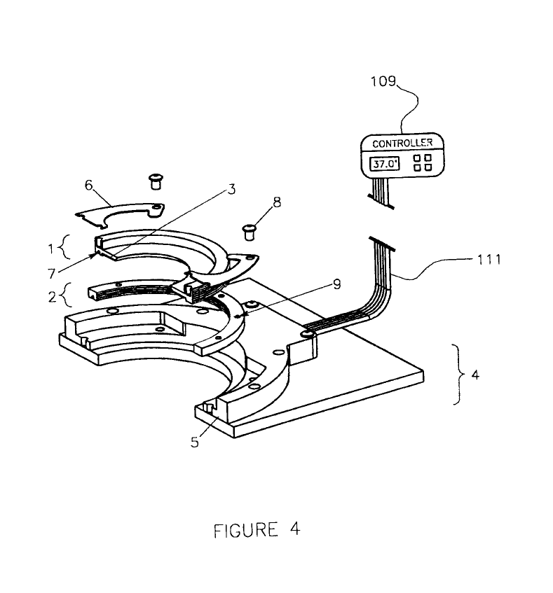

Referring now to FIGS. 2 and 3, there is illustrated in perspective cross section along the line II-II of FIG. 1, the novel heating and retaining assembly 5 of the present invention.

An inner heated ring 1 also known as a heated specimen retainer, supports the specimen 107 and provides heat by means of an electroresistive heater 3, which may be for example a thin foil heating element. The inner heated ring 1 is rotationally stationary being held from rotation by the combination of a plurality of screws 10 through spring bracket 6 and through or at least compressing against the inner heated ring 1. Note; there are other screws that hold together, spring bracket 6, screw 8 through spring bracket 6 and through spacer 5 and embedding in carrier plate 4. Although it is rotationally stationary, inner heated ring 1 is Z-axis adjustable via its threaded engagement with an outer rotating ring 2, (also known as a thermal expansion compensation adjustment ring) which threaded engagement is discussed in more detail below, whereupon by rotating outer rotating ring 2, inner heated ring 1 is translated up and down along a Z-axis.

The outer rotating ring 2 is internally threaded to interface with external threads on the outside periphery of the inner heated ring 1. Rotation of the outer rotating ring 2 causes the inner heated ring 1 to translate up and down in the Z-axis plane.

A carrier plate 4 provides mechanical support for the inner heated ring 1 and outer rotating ring 2. Carrier plate 4 rests upon, or, optionally alternatively, nests within the stage 103 of the microscope 100. For example, some stages include formed depressions designed to accept carrier plates of congruent shape which nest in such depressions. In the absence of such a nesting relationship, as may be appreciated, the geometric design of the periphery of the carrier plate 4 may take any form, including but not limited a rectangle, square, or circle for example.

The outer rotating ring 2 rests directly on the carrier plate 4 as shown in FIG. 2. A spacer 5 rests upon carrier plate 4 and surrounds the outer periphery of outer rotating ring 2, and spaces spring bracket 6 above carrier plate 4 a sufficient distance such that the ears of spring bracket 6 are able to place downward pressure on outer rotating ring 2 to hold outer rotating ring 2 firmly against carrier plate 4 while still allowing for rotational movement of outer rotating ring 2.

In a preferred embodiment, the spacer 5 is made large enough to also act as a strain relief for the control wires 111 as shown in FIG. 2. As the inner heated ring 1 is warmed by electroresistive heater 3, it in turn heats any specimen vessel placed upon it, and also transfers heat to outer rotating ring 2, and as they warm together, they will expand relative to their mounting/supporting surfaces. In the case of the outer rotating ring 2 that surface is the carrier plate 4. In the case of the inner heated ring 1 the supportive surface is its threadable engagement with the outer rotating ring 2. Via appropriate rotation of the outer rotating ring 2, the counter bore 7 of the inner heated ring 1 can be made coplanar with the interface or junction formed where outer rotating ring 2 and carrier plate 4 meet. As outer rotating ring 2 and inner heated ring 1 warm and expand, each one will cancel out the other's thermal expansion along the Z-axis, thus reducing or eliminating Z-axis drift.

The user will find that there are differences in the height of the specimen plane for the various types and brands of specimen containers, and in order to compensate for the thermal characteristics of these variables, the outer rotating ring 2 can be rotated to change the ratio of positive and negative expansion forces of the heated components relative to the interface between the carrier plate and the thermal expansion compensation adjustment ring.

In operation, the assembly 105 is simply placed on or is nested within the stage 103, (as are respectively appropriate depending upon the shape of the carrier plate 4 and the stage 103), of microscope 100. A closed loop electronic feedback heating controller 109 is plugged in and set to the appropriate temperature. The inner heated ring 1 is heated by the electroresistive heater 3 which will warm inner heated ring 1 and outer ring 2 to its selected setpoint temperature. The end user will then place their specimen contained within a specimen vessel, on the inner heated ring 1, preferably in a depression formed in inner heated ring 1 which is geometrically designed to accept the specimen vessel. The electroresistive heater 3 will supply heat to the inner heated ring 1, and heat radiating from the minimal thermal mass of the heating surface of the inner heated ring 1 will be transferred to the specimen vessel and in turn the specimen, thus warming the specimen. As may be appreciated, heat will radiate from the electroresistive heater 3 and the inner heated ring 1 in all directions. However there will be far less conductive heat transfer to the stage 103 of the microscope 100 because none of the heat conducting components (electroresistive heater 3, inner heated ring 1 and outer rotating ring 2) are in direct contact with the stage 103. And, because carrier plate 4 is made of a material having both low thermal expansion and low thermal conductivity, it does not conduct heat or induce thermal drift as did the all-metal carrier plates of the prior art. As the electroresistive heater 3 heats the inner heated ring 1, the metal inner heated ring 1 will expand in the Z-axis in a negative direction relative to the carrier plate 4 surface, but the outer ring will expand in a positive direction relative to the carrier plate 4 surface. Therefore the specimen lying upon it are maintained coplanar with the outer rotating ring 2/carrier plate 4 interface. Therefore the Z-axis position of the specimen plane will be unaffected as changes in energy occur during the thermal regulation process.

In circumstances where the thermal expansion of the material the specimen is placed upon (e.g. the specimen vessel) also contributes to Z-axis drift, which will vary depending upon its composition and thickness, the outer rotating ring 2 enables the user to dial in an offset to the position of the specimen resting plane. Once this offset is established and the system reaches equilibrium, it will be stable. Given a closed loop feedback control, energy levels will change in the heated components over time to compensate for changing ambient conditions and entropy but the Z-axis position of the specimen will remain neutral.

As may be appreciated, the geometry of the carrier plate 4 and the specimen supporting portion of inner heated ring 1 are not limiting to the invention, and that it is possible to construct a specimen holder around nearly any geometry used to contain biological specimens or other specimens for microscopic examinations. Examples include microscope chamber slides, multiwell slides such as SBS (Society of Biomolecular Screening), an industry standard, plates, various diameters of culture dishes and electrophysiology chambers.

While the present invention is helpful wherever it is desired to limit Z-axis drift, as may be appreciated, it will be particularly useful for obtaining time-lapse images of temperature controlled specimens on a microscope. Thus the novel assembly of the present invention provides an inexpensive yet superior means of warming microscopic specimens without contributing to Z-axis drift. While there are more sophisticated systems available for controlling Z-axis drift, there are many researchers that do not need such a high degree of accuracy. Such high end systems may be more expensive to purchase, operate and maintain. The present invention provides an inexpensive warming plate that does not induce Z-axis or focus drift that is easy to use and economically attractive to buy.

While this invention has been described as having a preferred design, the subject invention can be further modified within the spirit and scope of this disclosure. This application is therefore intended to cover any variations, uses, or adaptations of the subject invention using its general principles. Further, this application is intended to cover such departures from the present disclosure as come within known or customary practice in the art to which this invention pertains and that fall within the limits of the appended claims.

I claim:

1. A microscope specimen warmer comprising:
a) a plate structure having minimal thermal conductivity and a minimal expansion coefficient;
b) a support surface on the plate structure; and
c) a specimen resting surface that is supported by the support surface on the plate structure so that the support surface on the plate structure is at or near the same horizontal plane as a specimen within the specimen resting surface so that there is no detectable z-axis shift of the specimen when the specimen is heated.

2. A microscope specimen warmer as recited in claim 1 wherein the specimen resting surface is adjustable in the Z-axis with respect to the support surface.

3. A microscope specimen warmer as recited in claim 1 wherein the plate structure is a carrier plate designed to rest on or in a microscope stage.

4. A microscope specimen warmer as recited in claim 3 wherein the specimen resting surface is an offset support structure resting on the carrier plate comprising:
a) an outer support stepped at or near mid thickness; and
b) an inner support counter bored to be at or near the plane of the outer support.

5. A microscope specimen warmer as recited in claim 4 wherein the outer support and the inner support are mechanically operable so that the relationship of the inner support counter bore and the outer support surface can be changed.

6. A microscope specimen warmer as recited in claim 4 including a clamping bias that maintains contact between the specimen resting surface and the carrier plate.

7. A microscope specimen warmer as recited in claim 3 wherein the carrier plate has a carrier plate opening and the specimen resting surface comprises.
a) a spacer having a spacer opening, the spacer is supported by the carrier plate so that the spacer opening is aligned with the carrier plate opening, the spacer opening has a larger area than the carrier plate opening creating a ledge;
b) an outer rotating ring having an outer rotating ring opening with threads, the outer rotating ring supported by the carrier plate ledge so that the spacer surrounds the outer rotating ring; and
c) an inner heated ring having threads that engage outer rotating ring threads so that inner heated ring is within the outer rotating ring opening, when the outer rotating ring is rotated the Z-axis position of the inner ring is changed to allow for adjustment based on the specimen.

8. A microscope specimen warmer as recited in claim 7 including a spring bracket attached to the spacer to put downward pressure on the outer rotating ring to hold the outer rotating ring firmly against the carrier plate while still allowing for rotational movement.

9. A microscope specimen warmer as recited in claim 7 including heating elements on the inner heated ring.

10. A method for viewing a heated microscope specimen on a microscope without having visible Z-axis movement during the heating and viewing of the specimen comprising:
a) providing a microscope;
b) providing a carrier plate having minimal thermal conductivity and a minimal expansion coefficient;
c) providing a specimen resting surface connected to the carrier plate so that a support surface of the carrier plate is coplanar with a specimen;
d) providing the specimen that is supported by the specimen holder;
e) heating the specimen retainer and thereby heating the specimen; and
f) viewing the specimen with the microscope and with minimal z-axis movement of the specimen.

11. The method as recited in claim 10 wherein specimen holder is adjustable in the z-axis with respect to carrier plate.

12. The method as recited in claim 10 wherein heat produced to warm the specimen is not transferred to a microscope stage and does not induce thermal expansion of the microscope stage.

13. The method as recited in claim 10 wherein only heat is applied to or removed from the specimen resting surface.

14. The method as recited in claim 10 wherein the specimen resting surface is an offset support structure resting on the carrier plate comprising:
a) an outer support stepped at or near mid thickness; and
b) an inner support counter bored to be at or near the plane of the outer support.

15. The method as recited in claim 14 a clamping bias that maintains contact between the specimen resting surface and the carrier plate.

16. The method as recited in claim 10 wherein the specimen resting surface comprises:
a) a spacer having a spacer opening, the spacer is supported by the carrier plate so that the spacer opening is aligned with the carrier plate opening, the spacer opening has a larger area than the carrier plate opening creating a ledge
b) an outer rotating ring having an outer rotating ring opening with threads, the outer rotating ring supported by the carrier plate ledge so that the spacer surrounds the outer rotating ring; and
c) an inner heated ring having threads that engage outer rotating ring threads so that inner heated ring is within the outer rotating ring opening, when the outer rotating ring is rotated the z axis position of the inner ring is changed to allow for adjustment based on the specimen characteristics.

17. The method as recited in claim 11 wherein heat is only applied to or removed from the inner heated ring.
